(19) United States
(12) Patent Application Publication
(10) Pub. No.: US 2008/0015133 A1
(43) Pub. Date: Jan. 17, 2008

(54) Alkaline floor cleaning composition and method of cleaning a floor

(76) Inventors: Karen O. Rigley, Greensboro, NC (US); Joseph T. Thekkekandam, Siler City, NC (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/487,599

(22) Filed: Jul. 14, 2006

(51) Int. Cl. C09G 1/02

(52) U.S. Cl. 510/215

(57) ABSTRACT

An alkaline floor cleaning composition concentrate in the form of a liquid and an alkaline cleaning composition concentrate in the form of a solid are provided. The alkaline cleaning composition concentrate can be used to remove fresh, greasy soil and polymerized soil from a floor surface.

### FIELD OF THE INVENTION

The invention relates to an alkaline floor cleaning composition and to a method of cleaning a floor using an alkaline floor cleaning composition. The alkaline floor cleaning composition is available for the removal of fresh, greasy soils and polymerized soils commonly encountered in the food service industry.

### BACKGROUND OF THE INVENTION

Two types of greasy soils are often encountered on floors in the food service industry. One type of soil can be referred to as fresh, greasy soil, and the other type of soil can be referred to as polymerized soil. Fresh, greasy soils can result from the presence of fatty soil, which can comprise, for example, a neutral fatty acid triglyceride ester and similar neutral fats, and free fatty acids or salts thereof. The fatty acid salts can be formed from a cation such as sodium, calcium, magnesium, ferric, ferrous, etc. Polymerized soil refers to fats and fatty derivatives that have likely been polymerized through cross-linking in a manner similar to that of drying oils such as linseed oil. Polymerized soils present a different challenge compared to fresh, greasy soils.

Fresh, greasy soils can deposit on the floor and these greasy soil deposits can polymerize and adhere to the floor surface through cross linking. A type of floor surface often encountered in the food service industry can be referred to as quarry tile. In general, quarry tile is often arranged in a grid-like pattern to form a flooring surface and contains a cement-like material called grout provided in the joints between the quarry tile.

Traditionally, an alkaline or neutral cleaner is used for removing fresh, greasy soil from the floor and an acidic cleaner is used for removing polymerized soil from the floor surface. A product to clean fresh, greasy soils is available under the name KADET®-AF All Surface Floor Cleaner from Kay Chemical Company. A product available to clean fresh greasy soil and polymerized soils is available under the name KADET® Quarry Tile Floor Cleaner from Kay Chemical Company.

### SUMMARY OF THE INVENTION

An alkaline cleaning composition concentrate in the form of a liquid is provided according to the present invention. The alkaline cleaning composition concentrate comprises about 15 wt. % to about 65 wt. % water, about 5 wt. % to about 25 wt. % surfactant, about 4 wt. % to about 20 wt. % chelant, about 2 wt. % to about 10 wt. % buffer, and an alkalinity source sufficient to provide a free alkalinity (expressed as Na₂O) of about 1.5% to about 3.5% and a total alkalinity (expressed as Na₂O) of about 2.0% to about 6.0%. The composition exhibits an aluminum corrosion rate of less than 250 mils/year according to a modified version of ASTM G31-72, and is considered non-corrosive according to OSHA Hazard Communication Standard Rule (29 C.F.R. 1910.1200 App. A and B).

An alkaline cleaning composition concentrate in the form of a solid is provided according to the present invention. The alkaline cleaning composition concentrate comprises about 20 wt. % to about 65 wt. % surfactant, about 10 wt. % to about 30 wt. % chelant, 8 wt. % to about 20 wt. % hardening agent, and an alkalinity source sufficient to provide a free alkalinity (expressed as Na₂O) of about 1.5% to about 5.0% and a total alkalinity (expressed as Na₂O) of about 2.0% to about 10.0%. The composition can be provided so that it is considered non-corrosive according to OSHA Hazard Communication Standard Rule (29 C.F.R. 1910.1200 App. A and B).

A method of cleaning a floor is provided according to the present invention. The method can be practiced using the alkaline floor cleaning composition concentrate in the form of a liquid or the alkaline cleaning composition concentrate in the form of a solid. In general, the liquid concentrate or the solid concentrate is diluted with water of dilution to provide a use composition having a chelant level of at least about 100 ppm. The use composition can then be applied to a floor surface to provide cleaning of fresh, greasy soil and polymerized soil from the floor surface.

### DETAILED DESCRIPTION OF THE PREFERRED EMBODIMENT

The present invention is directed to an alkaline floor cleaning composition that can be used to remove fresh, greasy soil and polymerized soil from a floor surface. The alkaline floor cleaning composition can be referred to more simply as the cleaning composition. The alkaline floor cleaning composition can be provided as a concentrate or as a use composition. A use composition refers to a composition that is intended to be applied to a floor surface to provide cleaning properties. A use composition can be prepared as a result of diluting a concentrate with water of dilution.

The alkaline floor cleaning composition refers to a use composition having a pH of at least about 9.5, or to a concentrate that provides a use composition having a pH of at least about 9.5 when diluted with water of dilution.

Fresh, greasy soil refers to a type of soil deposit often found on the floors in the food service industry. In general, fresh, greasy soils can result from the presence of fatty soil, which can comprise, for example, a fatty acid triglyceride ester and similar fats, and free fatty acids or salts thereof. The fatty acid salts can be formed from a cation, such as sodium, calcium, magnesium, ferric ferrous, etc. Polymerized soil refers to another type of soil often encountered on floors in the food service industry. Polymerized soils generally refer to fats and fatty derivatives that have been polymerized through cross-linking in a manner similar to that of drying oils such as linseed oil. The polymerized film adheres to negatively charged surfaces such as quarry tile through bonding with water hardness ions such as calcium and magnesium as taught by Cockrell, Jr. et al. in U.S. Pat. Nos. 4,877,459 and 4,749,508.

The alkaline floor cleaning composition can be applied to various floor surfaces including quarry tile, vinyl composition tile, concrete, poured floors, etc. In general, quarry tile refers to ceramic tile and natural stone. Quarry tile is often found in food preparation environments such as restaurant kitchens, hospitals, food processing establishments, food preparation establishments, slaughter houses, packing plants, shortening production plants, etc.

The alkaline floor cleaning composition concentrate can be provided as a solid or as a liquid. When the concentrate is provided as a solid or as a liquid, the composition can be packaged and shipped without labeling the packaging as corrosive. The liquid concentrate can be provided as non-corrosive to aluminum so that the concentrate can avoid being labeled as corrosive under United States Department of Transportation regulations. A liquid composition that can be considered relatively non-corrosive to aluminum exhibits an aluminum corrosion rate of less than about 250 mils/year according to a modified version of ASTM G31-72. Accordingly, the liquid concentrate can be provided so that it exhibits an aluminum corrosion rate of less than about 250 mils/years according to a modified version of ASTM G31-72. A modified version of ASTM G31-72 is explained in the examples section. Furthermore, the composition can be considered non-corrosive when evaluated according to OSHA Hazard Communication Standard Rule (29 CFR 1910.1200 App. A and B).

Furthermore, the cleaning composition, when provided as a liquid, can be considered relatively stable and resistant to phase separation and precipitation at temperatures of 120° F. and 40° F. for at least 6 weeks.

### Alkalinity Source

The cleaning composition can include an alkalinity source to enhance detersive properties. In general, an alkalinity source refers to a component that causes the use composition to have a pH of at least about 9.5. In general, it is desirable to provide the use composition as a mildly alkaline cleaning composition because it is considered to be safer than use compositions based on caustic alkalis. A mildly alkaline cleaning composition refers to a composition having a pH below about 11.5.

The alkalinity source can be derived from an organic or inorganic alkali such as an alkanolamine, alkali metal carbonate, alkali metal hydroxide, phosphate, borate, silicate, or a mixture thereof. Exemplary alkanolamines that can be used include, for example, 2-amino-2-methyl-propanol, monoethanolamine, triethanolamine, diisopropanolamine, or mixtures thereof. Exemplary metal carbonates that can be used include, for example, sodium carbonate, potassium carbonate, sodium bicarbonate, potassium bicarbonate, sodium sesquicarbonate, potassium sesquicarbonate, or mixtures thereof. Exemplary alkali metal hydroxides that can be used include, for example, sodium hydroxide or potassium hydroxide. An alkali metal hydroxide may be added to the composition in the form of solid beads, dissolved in an aqueous solution, or a combination thereof. Alkali metal hydroxides are commercially available as a solid in the form of prilled solids or beads, or as an aqueous solution, for example, as a 50 wt. % and a 73 wt. % solution. Exemplary phosphates that can be used include, for example, sodium or potassium phosphates or polyphosphates.

### Buffering Agent

The alkaline floor cleaning composition can include a buffering agent to control the level of alkalinity. Basic buffering agents that can be used include a base and the alkali metal salt of a complementary acid. Exemplary bases include sodium bicarbonate, mixtures of sodium bicarbonate and sodium carbonate, disodium phosphate, monosodium phosphate, mixtures of disodium phosphate and trisodium phosphate, borates such as sodium tetraborate and borax, and combinations of carbonates and phosphates. Alkali metal or organic amine salts of organic acids can also be used. Examples include sodium, potassium or triethanolamine salts of acetic, citric, lactic or tartaric acids.

The alkaline floor cleaning composition can include a buffering agent in an amount sufficient to control the level of alkalinity in the concentrate. In general, the alkaline floor cleaning composition concentrate can include about 0 to about 10 wt. % buffer. The buffer can be considered an optional component and need not be included in the solid concentrate. When the solid concentrate includes a buffer, it can be included in an amount of at least about 0.1 wt. %. The solid concentrate can include about 0.1 wt. % to about 10 wt. % buffer, and can include about 4 wt. % to about 6 wt. % buffer. The liquid concentrate can include about 2 wt. % to about 10 wt. % buffer, and can include about 3 wt. % to about 5 wt. % buffer.

The alkalinity source and the buffering agent can be controlled so that the free alkalinity (expressed as Na₂O) is about 1.5% to about 3.5% or about 2.0% to about 3.4%, and the total alkalinity (expressed as Na₂O) is about 2.0 to about 6.0% or about 2.4% to about 4.0% when the alkaline cleaning composition concentrate is provided as a liquid. When the alkaline cleaning composition concentrate is provided as a solid, the alkalinity source and the buffer are provided in amounts sufficient so that the free alkalinity (expressed as Na₂O) is about 1.5% to about 5.0% or about 2.4% to about 4.0% and the total alkalinity (expressed as Na₂O) is about 2.0% to about 10.0% or about 6.0% to about 10.0%. Furthermore, the alkaline cleaning composition concentrate, whether a liquid or a solid, can be considered non-corrosive according to OSHA Hazard Communication Standard Rule (29 C.R.F. 1910.1200 App. A and B).

### Surfactants

The cleaning composition can include a surfactant selected from an anionic surfactant, nonionic surfactant, amphoteric surfactant or a combination thereof. Exemplary surfactants that can be used are commercially available from a number of sources. For a discussion of surfactants, see Kirk-Othmer, Encyclopedia of Chemical Technology, Third Edition, volume 8, pages 900-912.

Anionic surfactants useful in the cleaning composition includes, for example, carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates, alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, and the like. Exemplary anionic surfactants include sodium alkylarylsulfonate, alpha-olefinsulfonate, and fatty alcohol sulfates.

Nonionic surfactants useful in the cleaning composition include, for example, those having a polyalkylene oxide polymer as a portion of the surfactant molecule. Such nonionic surfactants include, for example, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated ethylene diamine; alcohol alkoxylates such as alcohol ethoxylates (Surfonic L12-6 commercially available from Huntsman), alcohol ethoxylate propoxylates, alcohol propoxylates, alcohol propoxylate ethoxylate propoxylates, alcohol ethoxylate butoxylates, and the like; nonylphenol ethoxylate, polyoxyethylene glycol ethers and the like; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and polyalkylene oxide block copolymers including an ethylene oxide/propylene oxide block copolymer such as those commercially available under the trademark PLURONIC® (BASF), and the like; and other like nonionic compounds. Silicone surfactants such as the ABIL® B8852 can also be used.

Amphoteric surfactants that can be used in the cleaning composition include betaines, imidazolines, sultaines and propionates.

The cleaning composition, when provided as a concentrate, can include the surfactant in an amount of about 5 wt. % to about 65 wt. %. When the concentrate is provided as a liquid concentrate, the concentrate can contain about 5 wt. % to about 25 wt. % surfactant, and can include about 8 wt. % to about 15 wt. % surfactant. When the cleaning composition concentrate is provided as a solid concentrate, the concentrate can contain about 20 wt. % to about 65 wt. % surfactant, and can include about 40 wt. % to about 60 wt. % surfactant.

### Chelating Agent

The cleaning composition can include a chelating/sequestering agents or builder. The cleaning composition can include chelating/sequestering agents such as aminocarboxylates. Exemplary aminocarboxylates include, for example, the alkali metal salts of methyl glycine diacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA) and N-hydroxyethyliminodiacetic acid.

Other chelating agents that may find use in this invention include condensed phosphates, phosphonates, polyacrylates, gluconates, citrates, and the like. In general, a chelating agent is a molecule capable of coordinating (i.e., binding) the metal ions commonly found in natural water to prevent the metal ions from interfering with the action of the other detersive ingredients of a cleaning composition. In general, chelating/sequestering agents can generally be referred to as a type of builder. The chelating/sequestering agent may also function as a threshold agent when included in an effective amount.

Examples of condensed phosphates include sodium and potassium pyrophosphate, sodium tripolyphosphate, sodium hexametaphosphate, and the like. A condensed phosphate may also assist, to a limited extent, in solidification of the composition by fixing the free water present in the composition as water of hydration.

The composition may include a phosphonate such as 1-hydroxyethane-1,1-diphosphonic acid CH₃C(OH)[PO(OH)₂]₂(HEDP); amino tri(methylenephosphonic acid) N[CH₂PO(OH)₂]₃; aminotri(methylenephosphonate), sodium salt

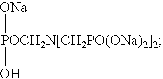

2-hydroxyethyliminobis(methylenephosphonic acid) HOCH₂CH₂N[CH₂PO(OH)₂]₂; diethylenetriaminepenta(methylenephosphonic acid) (HO)₂POCH₂N[CH₂CH₂N[CH₂PO(OH)₂]₂]₂; diethylenetriaminepenta(methylenephosphonate), sodium salt C₉H₍₂₈₋ₓ₎N₃NaₓO₁₅P₅ (x=7); hexamethylenediamine(tetramethylenephosphonate), potassium salt C₁₀H(₂₈₋ₓ₎N₂KₓO₁₂P₄ (x=6); bis(hexamethylene)triamine(pentamethylenephosphonic acid) (HO₂)POCH₂N[(CH₂)₆N[CH₂PO(OH)₂]₂]₂; and phosphorus acid H₃PO₃. Exemplary phosphonates are HEDP, ATMP and DTPMP. A neutralized or alkaline phosphonate, or a combination of the phosphonate with an organic or inorganic alkali source prior to being added into the mixture such that there is little or no heat or gas generated by a neutralization reaction when the phosphonate is added is preferred when solidification of composition is desired. The phosphonate can comprise a potassium or sodium salt of an organo phosphonic acid (a potassium phosphonate). The potassium salt of the phosphonic acid material can be formed by neutralizing the phosphonic acid with an aqueous potassium hydroxide solution during the manufacture of the solid detergent. The phosphonic acid sequestering agent can be combined with a potassium hydroxide solution at appropriate proportions to provide a stoichiometric amount of potassium hydroxide to neutralize the phosphonic acid. A potassium hydroxide having a concentration of from about 1 to about 50 wt % can be used. The phosphonic acid can be dissolved or suspended in an aqueous medium and the potassium hydroxide can then be added to the phosphonic acid for neutralization purposes.

For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein.

The cleaning composition concentrate can include the chelant in an amount sufficient to provide desired chelating properties. The cleaning composition concentrate can include the chelant in an amount of about 4 wt. % to about 30 wt. %. When the cleaning composition concentrate is provided as a liquid concentrate, the concentrate can contain about 4 wt. % to about 20 wt. % chelant, or about 6 wt. % to about 10 wt. % chelant. When the cleaning composition concentrate is provided as a solid concentrate, the concentrate can contain about 10 wt. % to about 30 wt. % chelant or about 15 wt. % to about 25 wt. % chelant.

### Processing Aid

The cleaning composition concentrate may further include one or more optional processing aids. Such optional processing aids may provide one or more processing advantages during processing of the above-described solid cleaning product components and/or one or more desirable properties to the resulting solid cleaning product. Suitable processing aids for use in the present invention include sodium sulfate, sodium chloride, potassium sulfate, potassium chloride, and urea. In an embodiment, the processing aid includes anhydrous sodium sulfate or urea.

A number of commercially available processing aids may be used in the present invention. Suitable commercially available process aids include, but are not limited to, sodium sulfate available from Haarmann & Reimer Corporation (Elkhart, Ind.), and urea available from Mallinckrodt Baker, Inc. (Phillipsburg, N.J.).

The cleaning composition concentrate can include up to about 15 percent by weight (wt. %) of one or more processing aids based on a total weight of the solid cleaning product. The processing aid can be considered an optional component and need not be included in the cleaning composition concentrate. When the processing aid is included in the cleaning composition concentrate, it can be included in an amount of at least about 0.1 wt. %. The liquid concentrate can include about 0.1 wt. % to about 15 wt. % processing aid, and can include about 6 wt. % to about 12 wt. % processing aid. The processing aid can be excluded from the solid concentrate, if desired.

### Hardening Agent

The alkaline floor cleaning composition concentrate can be provided as a solid. When the concentrate is provided as a solid, the composition can be solidified as a result of the presence of a hardening agent. Exemplary hardening agents that can be included in the composition to solidify the composition include urea, polyethylene glycol, hydratable inorganic salts of sulfate, acetate, carbonate, bicarbonate, and phosphate, or mixture thereof.

A hardening agent can be a compound or system of compounds, organic or inorganic, that significantly contributes to the uniform solidification of the composition. Preferably, the hardening agent is compatible with the cleaning agent and other active ingredients of the composition, and is capable of providing an effective amount of hardness and/or aqueous solubility to the composition. The hardening agent can be capable of forming a homogeneous matrix with the cleaning agent and other ingredients when mixed and solidified to provide a uniform dissolution of the cleaning agent from the solid composition during use.

The amount of hardening agent included in the cleaning composition concentrate can vary according to the components of the cleaning composition, the intended use of the composition, the amount of water in the cleaning composition concentrate, the temperature of the water of dilution used to form the use composition, the hardness of the water, the physical size of the solid concentrate, the concentration of the other ingredients, the concentration of the cleaning agent in the composition, and other like factors. It is preferred that the amount of the hardening agent is effective to form a homogenous mixture under continuous mixing conditions and a temperature at or below the melting temperature of hardening agent.

It is also preferred that the hardening agent will form a matrix with the cleaning agent and other ingredients which will harden to a solid form under ambient temperatures of about 30-50° C. after mixing ceases and the mixture is dispensed from the mixing system, within about 1 minute to about 3 hours, preferably about 2 minutes to about 2 hours, preferably about 5 minutes to about 1 hour, in order for the product to be molded or extruded into a desired shape and size. A minimal amount of heat from an external source may be applied to the mixture to facilitate processing of the mixture. It is preferred that the amount of hardening agent included in the composition is effective to provide a hardness and desired rate of controlled solubility of the processed composition when placed in an aqueous medium to achieve a desired rate of dispensing the cleaning agent from the solidified composition during use.

The hardening agent may be, for example, an amide such as stearic monoethanolamide, lauric diethanolamide, and stearic diethanolamide, available commercially from Stepan Chemical under the trademark NINOL™ and from Scher Chemical Company under the trademark SCHERCO-MID™. Alkyl amides particularly provide varying degrees of hardness and solubility when combined with cationizing surfactants. Generally, the C₁₆ to C₁₈ straight chain aliphatic alkyl amides provide a higher degree of insolubility with the higher degree of hardness. For a further discussion of alkyl amide hardening agents, see U.S. Pat. No. 5,019,346 to Richter, the disclosure of which is incorporated by reference herein.

Another hardening agent is a polyethylene glycol (PEG) or propylene glycol compound for use in a cleaning composition comprising a nonionic surfactant cleaning agent, such as a nonyl phenol ethoxylate, a linear alkyl alcohol ethoxylate, an ethylene oxide/propylene oxide block copolymer such as surfactants available commercially under the trademark PLURONIC™ from BASF-Wyandotte. The solidification rate of cleaning compositions comprising a polyethylene glycol hardening agent made according to the invention will vary, at least in part, according to the amount and the molecular weight of the polyethylene glycol added to the composition.

Polyethylene glycol compounds useful according to the invention include, for example, solid polyethylene glycols of the general formula H(OCH₂—CH₂)ₙOH, where n is greater than 15, more preferably about 30-1700. Solid polyethylene glycols which are useful are marketed under the trademark Carbowax™, and are commercially available from Union Carbide. Preferably, the polyethylene glycol is a solid in the form of a free-flowing powder or flakes, having a molecular weight of about 1000-10,000, preferably about 3000-8000. Suitable polyethylene glycol compounds useful according to the invention include, for example, PEG 900, PEG 1000, PEG 1500, PEG 4000, PEG 6000, PEG 8000 among others, with PEG 8000 being preferred.

The hardening agent may also be a hydratable substance such as an anhydrous sodium carbonate, anhydrous sodium sulfate, anhydrous polyphosphonates, etc., or a mixture thereof. Preferably, the hydratable hardening agent is used in an alkaline cleaning composition which includes ingredients such as condensed phosphate hardness sequestering agent and an alkaline builder salt wherein the amount of caustic builders is about 5-15 wt-%, as disclosed, for example in U.S. Pat. Nos. 4,595,520 and 4,680,134 to Heile et al., the disclosures of which are incorporated by reference herein. A hydratable hardening agent, according to the invention, is capable of hydrating to bind free water present in a liquid detergent emulsion to the extent that the liquid emulsion becomes hardened or solidified to a homogenous solid. The amount of a hydratable substance included in a detergent composition processed according to the invention, will vary according to the percentage of water present in the liquid emulsion as well as the hydration capacity of the other ingredients.

Other hardening agents that may be used in a cleaning composition processed according to the invention include, for example, urea, also known as carbamide, starches that have been made water-soluble through an acid or alkaline treatment process, and various inorganics that impart solidifying properties to a heated liquid matrix upon cooling.

The alkaline cleaning composition concentrate includes 0 to about 20 wt. % of the hardening agent. It should be appreciated that the hardening agent is an optional component and need not be included in the liquid concentrate. In general, for the solid concentrate, it is expected that the solid concentrate will include about 8 wt. % to about 20 wt. % hardening agent, and can include about 9 wt. % to about 16 wt. % hardening agent.

### Hydrotropes/Stabilizers

Hydrotropes/stabilizers can be provided in the liquid concentrate to help stabilize the composition. Exemplary hydrotropes that can be used include sodium xylene sulfonate, sodium toluene sulfonate, sodium naphthalene sulfonate, sodium cumene sulfonate, alkydiphenyloxide disulfonates, glycerine, organic diacids, propylene glycol, hexylene glycol, isopropanol, ethanol, glycol ethers and mixtures thereof. Hydrotropes are optional and can be excluded from the concentrate.

When the concentrate includes a hydrotrope, the hydrotrope can be provided in an amount of about 0.1 wt. % to about 10 wt. %. In the case of the liquid concentrate, the hydrotrope can be provided in an amount of about 3 wt. % to about 6 wt. %. The chelant can be excluded from the solid concentrate.

### Water

The cleaning composition concentrate can include water. In general, water can be present to aid in the flow of the concentrate, and water can be present as water of hydration. It is expected that water can be present in both the liquid concentrate and in the solid concenrates. In general the concentrate can contain 0 to about 85 wt. % water. When water is present in the concentrate, it can be present in an amount of at least about 0.1 wt. %. In the case of a liquid concentrate, the concentrate can include about 15 wt. % to about 85 wt. % water, and can include about 45 wt. % to about 75 wt. % water. In the case of a solid concentrate, the concentrate can contain 0 wt. % water or, if water is present, about 0.1 wt. % to about 5 wt. % water, at about 0.4 wt. % to about 0.8 wt. % water.

The concentrate can be diluted with water (water of dilution) to provide a use composition for removing fresh, greasy soil and polymerized soil from a floor surface. The amount of water of dilution can be selected to provide a use composition having a chelant concentration of at least about 100 ppm, at least about 200 ppm, or at least about 250 ppm to provide desired soil removal properties.

### Additives

The solid cleaning products of the present invention may contain one or more additives to provide a desired characteristic to the cleaning composition. Suitable additives include, but are not limited to, colorants (i.e., dyes, pigments, etc.), perfumes, preservatives, antioxidants, UV stabilizers, and combinations thereof. In one desired embodiment of the present invention, the cleaning composition includes at least one colorant to provide a desirable color, and at least one perfume or fragrance to provide a desirable scent.

Various dyes, odorants including perfumes, and other aesthetic enhancing agents can be included in the cleaning composition. Dyes may be included to alter the appearance of the composition, as for example, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keystone Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like.

In an embodiment, additives such as colorants, perfumes, antioxidants, UV stabilizers, and preservatives, are each individually present in an amount of less than about 0.5 wt-% based on a total weight of the solid cleaning product. In an embodiment, the amount of colorant in the solid cleaning product, when present, ranges from about 0.0005 to about 0.015 wt-% based on a total weight of the solid cleaning product. When a perfume or fragrance is present, the amount of perfume or fragrance can be from about 0.01 to about 0.25 wt % based on a total weight of the solid cleaning product. In an embodiment, when present, one or more preservatives are present in the solid cleaning product in an amount ranging from about 0.001 to about 0.01 wt % based on a total weight of the solid cleaning product.

Fragrances or perfumes that may be included in the compositions include, for example, terpenoids such as citronellol, aldehydes such as amyl cinnamaldehyde, a jasmine such as C1S-jasmine or jasmal, vanillin, and the like.

The amounts of the components of the concentrate can be selected depending upon whether the concentrate is provided as a liquid concentrate or as a solid concentrate. Exemplary ranges for the components for the concentrate are identified in Table 1. Table 1 additionally includes ranges of components when the concentrate is provided as a liquid and ranges of the components when the concentrate is provided as a solid.

TABLE 1
Ranges of Components for Liquid and Solid Concentrate

| | | Liquid | Liquid | Solid | Solid |
|---|---|---|---|---|---|
| | Concentrate | Concentrate | Concentrate | Concentrate | Concentrate |
| Component | (wt. %) | (wt. %) | (wt. %) | (wt. %) | (wt. %) |
| Water | 0–85 | 15–85 | 45–75 | 0–5 | 0.4–0.8 |
| Surfactant | 5–65 | 5–25 | 8–15 | 20–65 | 40–60 |
| Chelant | 4–30 | 4–20 | 6–10 | 10–30 | 15–25 |
| Buffer | 0–10 | 2–10 | 3–5 | 0–10 | 4–6 |
| Processing | 0–15 | 0–15 | 6–12 | 0–15 | 0 |
| aid | | | | | |
| Hardening | 0–20 | 0 | 0 | 8–20 | 9–16 |
| agent | | | | | |
| Free alkalinity | 1.5–5.0% | 1.5–3.5% | 2.0–3.4% | 1.5–5.0% | 2.4–4.0 |
| (expressed | | | | | |
| as Na₂O) | | | | | |
| Total | 2.0–10.0% | 2.0–6.0% | 2.4–4.0% | 2.0–10.0% | 6.0–10.0 |
| alkalinity | | | | | |
| (expressed | | | | | |
| as Na₂O) | | | | | |

Titration method: Alkalinity expressed as Na₂O
Titrate a 2.0 g sample diluted with 100 mls of water to the phenolphthalein and methyl orange endpoints with 0.5N sulfuric acid. The phenolphthalein endpoint refers to the free alkalinity, and the methyl orange endpoint refers to the total alkalinity.

$$\% {Na}_{2} O = \frac{mls titrant \times .0155 \times 100}{sample weight}$$

The alkaline cleaning composition concentrate can be diluted with water of dilution to provide a use composition that exhibits desired removal of fresh, greasy soil and polymerized soil from a floor surface. In general, the alkaline cleaning composition concentrate can be diluted with a sufficient amount of water to provide a use composition containing a chelant level of at least about 100 ppm, preferably greater than about 200 ppm, and more preferably greater than about 250 ppm. It is expected that a use composition prepared from the alkaline cleaning composition concentrate and can contain a chelant level of at least about 100 ppm, prefererably at least about 200 ppm, and more preferably greater than about 250 ppm can provide desired soil removal properties.

### EXAMPLE

Several exemplary concentrates were prepared by mixing the components identified in Table 2. In Table 2, the amounts of components are provided at weight percents. The aluminum corrosion in mils/year reported in Table 2 was determined based upon a modification of ASTM G31-72. The procedure for determination of aluminum corrosion rate according to the modified ASTM G31-72 is described following Table 2.

TABLE 2

| | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|
| Water | 33.1 | 35.9 | 35.1 | 36.0 | 35.5 | 34.1 | 35.1 | 43.6 | 47.2 | 45.2 | 36.1 | 47.4 | 46.4 | 37.1 | 48.4 | 38.1 |
| Boric acid | 0.0 | 0.0 | 0.0 | 0.0 | 4.0 | 4.0 | 3.0 | 3.0 | 2.0 | 2.0 | 2.0 | 0.0 | 0.0 | 1.0 | 0.0 | 0.0 |
| Sodium borate | 0.0 | 0.0 | 0.0 | 0.0 | 0.0 | 0.0 | 0.0 | 0.0 | 0.0 | 0.0 | 0.0 | 2.0 | 2.0 | 0.0 | 0.0 | 0.0 |
| Sodium bicarbonate | 5.0 | 4.0 | 3.0 | 3.0 | 0.0 | 0.0 | 0.0 | 0.0 | 0.0 | 0.0 | 0.0 | 0.0 | 0.0 | 0.0 | 0.0 | 0.0 |
| Sodium hydroxide 50% | 3.4 | 4.6 | 3.4 | 2.5 | 5.0 | 3.4 | 3.4 | 3.4 | 2.8 | 2.8 | 3.4 | 1.6 | 1.6 | 3.4 | 1.6 | 3.4 |
| 2-amino-2-methyl-1- | 3.0 | 0.0 | 3.0 | 3.0 | 0.0 | 3.0 | 3.0 | 3.0 | 1.0 | 3.0 | 3.0 | 2.0 | 3.0 | 3.0 | 3.0 | 3.0 |
| propanol¹ | | | | | | | | | | | | | | | | |
| Methyl glycine diacetic | 20.0 | 20.0 | 20.0 | 20.0 | 20.0 | 20.0 | 20.0 | 20.0 | 20.0 | 20.0 | 20.0 | 20.0 | 20.0 | 20.0 | 20.0 | 20.0 |
| acid, trisodium salt in | | | | | | | | | | | | | | | | |
| water 40%² | | | | | | | | | | | | | | | | |
| Dodecylbenzene sulfonic | 6.0 | 6.0 | 6.0 | 6.0 | 6.0 | 6.0 | 6.0 | 6.0 | 6.0 | 6.0 | 6.0 | 6.0 | 6.0 | 6.0 | 6.0 | 6.0 |
| acid | | | | | | | | | | | | | | | | |
| C10–C12 alcohol | 4.0 | 4.0 | 4.0 | 4.0 | 4.0 | 4.0 | 4.0 | 4.0 | 4.0 | 4.0 | 4.0 | 4.0 | 4.0 | 4.0 | 4.0 | 4.0 |
| ethoxylate³ | | | | | | | | | | | | | | | | |
| Sodium | 4.0 | 4.0 | 4.0 | 4.0 | 4.0 | 4.0 | 4.0 | 4.0 | 4.0 | 4.0 | 4.0 | 4.0 | 4.0 | 4.0 | 4.0 | 4.0 |
| lauroamphoacetate | | | | | | | | | | | | | | | | |
| 30%⁴ | | | | | | | | | | | | | | | | |
| Propylene glycol | 7.5 | 7.5 | 7.5 | 7.5 | 7.5 | 7.5 | 7.5 | 3.0 | 3.0 | 3.0 | 7.5 | 3.0 | 3.0 | 7.5 | 3.0 | 7.5 |
| Sodium xylene | 14.0 | 14.0 | 14.0 | 14.0 | 14.0 | 14.0 | 14.0 | 10.0 | 10.0 | 10.0 | 14.0 | 10.0 | 10.0 | 14.0 | 10.0 | 14.0 |
| sulfonate 40% | | | | | | | | | | | | | | | | |
| Total | 100.0 | 100.0 | 100.0 | 100.0 | 100.0 | 100.0 | 100.0 | 100.00 | 100.0 | 100.0 | 100.0 | 100.0 | 100.0 | 100.0 | 100.0 | 100.0 |
| pH | 10.5 | 10.6 | 11.0 | 10.6 | 10.3 | 10.1 | 10.4 | 10.5 | 10.3 | 10.6 | 11.0 | 10.9 | 11.1 | 13.0 | 12.2 | 13.2 |
| Free alkalinity (as Na2O) | 3.0 | 2.5 | 3.0 | 2.7 | 2.6 | 2.7 | 2.7 | 2.7 | 1.8 | 2.5 | 2.8 | 2.1 | 2.4 | 2.8 | 2.1 | 2.9 |
| Total alkalinity (as Na2O | 5.2 | 4.4 | 4.5 | 4.2 | 3.4 | 3.4 | 3.2 | 3.4 | 2.6 | 3.1 | 3.3 | 2.7 | 3.1 | 3.4 | 2.5 | 3.3 |
| Aluminum corrosion | 16 | 90 | 140 | 62 | 103 | 34 | 130 | 135 | 230 | 400 | 674 | 914 | 995 | 1304 | 1507 | 1939 |
| (mils/yr) | | | | | | | | | | | | | | | | |

¹Available under the name AMP 95 from Angus.
²Available under the name Trilon M from BASF.
³Available under the name Surfonic L 12-6 from Huntsman.
⁴Available under the name Miranol HMA from Rhodia.

In interpreting the data presented in Table 2, it should be understood that a higher level of alkalinity generally provides increased performance for the removal of soil from a floor surface. Accordingly, providing a composition having a lower alkalinity level may satisfy the aluminum corrosion resistance test, but it is expected that performance may suffer.

### Determination of Aluminum Corrosion Rate

The aluminum corrosion rate can be determined according to ASTM G31-72 and NACE Standard TMO 169-76. The method for determining aluminum corrosion rate reported in Table 2 can be referred to as a modified version of ASTM G31-72, and can be can be carried out as follows:

### Equipment:

### Water bath or oven capable of maintaining 113° F.+/−1.8° F. (45° C.+/−1.0° C.).

### Balance capable of weighing to 0.1 milligram

### Wide mouth glass jars, 16 oz, with lids

### Thermometer

### Aluminum panels, 7075-T6 alloy, 1″×2″× 1/16″ (panel area=4 in²)

70% nitric acid
99% isopropanol

### Tongs

### Chemical resistant gloves

### Procedure:

Add 400 ml of the product to be tested to each of two 16-ounce jars. Cap and place in the water bath and allow to equilibrate to 113° F.+/−1.8° F. (45° C.+/−1.0° C.) for 30 minutes.
While the product is equilibrating, prepare the metal panels as follows:

### For aluminum, etch 2 panels by placing 70% nitric acid in ajar and soaking the panel for two minutes, followed by a hot water rinse and finally an isopropanol rinse.

### Air dry the panels and weigh to the nearest 0.1 milligram.

Immerse the panels in the heated product for six hours. Lean the panels against the side of the jar. Do not lay the panel on the bottom of the jar. Run only one panel per jar.
At the conclusion of the test, remove aluminum panels, using tongs and chemical resistant gloves. Aluminum panels should be rinsed in hot water and placed in 70% nitric acid for two minutes. Rinse in hot water and then isopropanol.

Air dry the panels and weigh to the nearest 0.1 milligram.

### Determine the loss in weight for each panel in milligrams.

### Calculation:

$$MPY ( mils \text{/} year ) Corrosion = \frac{wt loss ( mg ) \times 534}{4 {in}^{2} ( panel area ) \times 6 hrs ( time ) \times 2.71 g \text{/} {cm}^{3} ( metal density )}$$

The above specification, examples and data provide a complete description of the manufacture and use of the composition of the invention. Since many embodiments of the invention can be made without departing from the spirit and scope of the invention, the invention resides in the claims hereinafter appended.

We claim:

1. An alkaline cleaning composition concentrate in the form of a liquid comprising:
(a) about 15 wt. % to about 65 wt. % water;
(b) about 5 wt. % to about 25 wt. % surfactant;
(c) about 4 wt. % to about 20 wt. % chelant;
(d) about 2 wt. % to about 10 wt. % buffer; and
(e) an alkalinity source sufficient to provide a free alkalinity (expressed as Na₂O) of about 1.5% to about 3.5% and a total alkalinity (expressed as Na₂O) of about 2.0% to about 6.0%;
wherein the composition exhibits an aluminum corrosion rate of less than 250 mils/year according to a modified version of ASTM G31-72, and is considered non-corrosive according to OSHA Hazard Communication Standard Rule (29 C.F.R. 1910.1200 App. A and B).

2. An alkaline cleaning composition concentrate according to claim 1, wherein the alkalinity source comprises of at least of alkanolamine, alkali metal carbonate, alkali metal hydroxide, phosphate, borate, silicate, or mixture thereof.

3. An alkaline cleaning composition concentrate according to claim 1, wherein the surfactant comprises an anionic surfactant, a nonionic surfactant, an amphoteric surfactant, or a mixture thereof.

4. An alkaline cleaning composition concentrate according to claim 1, wherein the surfactant comprises a mixture of anionic surfactant and nonionic surfactant.

5. An alkaline cleaning composition concentrate according to claim 1, wherein the chelant comprises aminocarboxylate, phosphate, phosphonate, polyacrylate, gluconate, citrate, or mixture thereof.

6. An alkaline cleaning composition concentrate according to claim 1, further comprising about 0.1 wt. % to about 15 wt. % of a processing aid.

7. An alkaline cleaning composition concentrate according to claim 6, wherein the processing aid comprises sodium sulfate, sodium chloride, potassium sulfate, potassium chloride, urea, or mixture thereof.

8. An alkaline cleaning composition concentrate in the form of a solid comprising:
(a) about 20 wt. % to about 65 wt. % surfactant;
(b) about 10 wt. % to about 30 wt. % chelant;
(c) about 8 wt. % to about 20 wt. % hardening agent; and
(d) an alkalinity source sufficient to provide a free alkalinity (expressed as Na₂O) of about 1.5% to about 5.0% and a total alkalinity (expressed as Na₂O) of about 2.0% to about 10.0%;
wherein the composition is considered non-corrosive according to OSHA Hazard Communication Standard Rule (29 C.F.R. 1910.1200 App. A and B).

9. An alkaline cleaning composition concentrate according to claim 8, wherein the alkalinity source comprises of at least of alkanolamine, alkali metal carbonate, alkali metal hydroxide, phosphate, borate, silicate, or mixture thereof.

10. An alkaline cleaning composition concentrate according to claim 8, wherein the surfactant comprises an anionic surfactant, a nonionic surfactant, an amphoteric surfactant, or a mixture thereof.

11. An alkaline cleaning composition concentrate according to claim 8, wherein the surfactant comprises a mixture of anionic surfactant and nonionic surfactant.

12. An alkaline cleaning composition concentrate according to claim 8, wherein the chelant comprises aminocarboxylate, phosphate, phosphonate, polyacrylate, gluconate, citrate, or mixture thereof.

13. An alkaline cleaning composition concentrate according to claim 8, further comprising about 0.1 wt. % to about 20 wt. % of a hardening agent.

14. An alkaline cleaning composition according to claim 13, wherein the hardening agent comprises urea, polyethylene glycol, hydratable inorganic salt, or mixture thereof.

15. A method of cleaning a floor comprising:
diluting an alkaline cleaning concentrate in the form of a liquid with a sufficient amount of water to provide a use composition containing a chelant concentration of at least about 100 ppm, the alkaline cleaning concentrate comprising:
(a) about 15 wt. % to about 65 wt. % water;
(b) about 5 wt. % to about 25 wt. % surfactant;
(c) about 4 wt. % to about 20 wt. % chelant;
(d) about 2 wt. % to about 10 wt. % buffer; and
(e) an alkalinity source sufficient to provide a free alkalinity (expressed as Na₂O) of about 1.5% to about 3.5% and a total alkalinity (expressed as Na₂O) of about 2.0% to about 6.0%;
wherein the composition exhibits an aluminum corrosion rate of less than 250 mils/year according to a modified version of ASTM G31-72, and is considered non-corrosive according to OSHA Hazard Communication Standard Rule (29 C.F.R. 1910.1200 App. A and B); and
applying the use composition to a floor for the removal of fresh, greasy soil and polymerized soil.

16. A method of cleaning a floor comprising:
diluting an alkaline cleaning composition concentrate in the form of a solid with a sufficient amount of water to provide a use composition containing a chelant concentration of at least about 100 ppm, the alkaline cleaning concentrate comprising:
(a) about 20 wt. % to about 65 wt. % surfactant;
(b) about 10 wt. % to about 30 wt. % chelant;
(c) about 8 wt. % to about 20 wt. % hardening agent; and
(d) an alkalinity source sufficient to provide a free alkalinity (expressed as Na₂O) of about 1.5% to about 5.0% and a total alkalinity (expressed as Na₂O) of about 2.0% to about 10.0%;
wherein the composition is considered non-corrosive according to OSHA Hazard Communication Standard Rule (29 C.F.R. 1910.1200 App. A and B); and
applying the use composition to a floor for the removal of fresh, greasy soil and polymerized soil.
